(19) United States
(12) Patent Application Publication
(10) Pub. No.: US 2025/0121762 A1
(43) Pub. Date: Apr. 17, 2025

(54) HOIST SYSTEM FOR CLASS 3 VEHICLE

(71) Applicant: DEIST INDUSTRIES, INC., Hadley, PA (US)

(72) Inventors: Derek Connors, Hadley, PA (US); Benjamin Post, Hadley, PA (US)

(73) Assignee: DEIST INDUSTRIES, INC., Hadley, PA (US)

(21) Appl. No.: 18/915,006

(22) Filed: Oct. 14, 2024

Related U.S. Application Data
(60) Provisional application No. 63/591,094, filed on Oct. 17, 2023.

(51) Int. Cl. B60P 1/64

(52) U.S. Cl. CPC B60P 1/6427; B60P 1/6409; B60P 1/649

(57) ABSTRACT

Provided in this disclosure is a hoist system for a Class 3 vehicle. The hoist system is particularly sized for Class 3 vehicles and includes a hoist frame, a subframe, a pivotal connection, a linkage, a plurality of connection brackets, and a winch assembly. Further, the hoist system has a body lock mechanism having a plurality of tabs, a plurality of body lock arms, and connection holes. Also included in the hoist system is an accessory mounting system having a plurality of accessory brackets, horizontal slots, and connection holes.

### I. BACKGROUND

### A. Technical Field

This invention pertains generally to the field of vehicles, such as trucks, that employ interchangeable bodies. In particular, the invention pertains to hoists that are used for raising and mounting an interchangeable vehicle body onto a vehicle chassis.

### B. Description of Related Art

Vehicles such as trucks are known to have different types of bodies, including a flat bed, a dumping body, an enclosed freight body, etc. Trucks of the same class can have various different bodies mounted onto the same chassis. Typically, vehicles such as trucks have a dedicated body that is permanently mounted to a chassis. Such a truck is sold and used as one type of special purpose vehicle, for handling the special types of jobs associated with the dedicated body.

Vehicles with dedicated bodies are limited in use for only the types of special jobs that can be performed by that particular body. For example, a dump truck is only useful for dumping. Such vehicles can remain idle while their associated types of jobs are not being performed. A small business may not have the available resources to purchase and maintain a fleet of dedicated vehicles having different bodies. For this reason, vehicles having interchangeable bodies are known to have certain useful advantages. A truck using interchangeable bodies enables the same single vehicle to be converted and adapted for use with a variety of different jobs, without requiring a fleet of separate vehicles to be maintained.

Such vehicles with interchangeable bodies typically include a hoist for raising and mounting an interchangeable body onto a vehicle chassis. Such a common-type hoist includes a movable hoist frame for supporting an interchangeable body, which is mounted to a subframe that is welded onto the vehicle chassis. In this manner, the subframe is maintained in a fixed position. The hoist frame can be selectively elevated and inclined in such a manner as to allow an interchangeable body to be slidably mounted upon the chassis.

Though there are benefits to using interchangeable bodies, vehicles with interchangeable bodies are also subject to certain drawbacks. Such a vehicle must be dedicated for the specific use of mounting interchangeable bodies, since a welded hoist often precludes conversion to another single use vehicle. It is thus difficult to convert the vehicle back to other uses besides mounting interchangeable bodies due to damage to the chassis from welding. Also, welding is typically outsourced to a professional welder rather than performed by on-site personnel.

Moreover, the hoist can become damaged from repeated mountings and remountings of different types of interchangeable bodies. Replacing a damaged hoist can be a time-consuming matter due in part to scheduling outsourced welding services, resulting in vehicle down time. And the chassis can be further damaged by repeated welding operations from repeated hoist replacements, which can shorten vehicle life or require additional vehicle servicing to repair or replace the chassis.

In addition, previous type welded hoist systems are specifically sized to only permit a single length of interchangeable body to be deployed. Moreover, in such welded hoist systems, the components for elevating the hoist frames are hard mounted at a fixed maximum angle, which reduces the usefulness of certain interchangeable body types for certain applications.

Further, previous hoist systems are sized specifically for larger vehicles and cannot be used on trucks sized Class 3 or below. Additionally, shifting, moving, and jostling of frames within the hoist system can lead to wear and damage to both the hoist and interchangeable body.

### II. SUMMARY

In accordance with an aspect of the present invention, a hoist system for raising and mounting an interchangeable vehicle body onto a vehicle chassis. The hoist includes a hoist frame having first and second parallel frame members, extending along a longitudinal axis of the hoist frame between an elevated end and a pivot end, for slidably supporting the interchangeable vehicle body. Also provided is a subframe including first and second parallel subframe members and having mounting portions on each of the subframe members, the mounting portions including a series of mounting holes for receiving bolts for fixedly connecting to the vehicle chassis, and a pivotal connection for pivotally connecting the pivot end of the hoist frame to the subframe. A linkage is included for connecting the hoist frame to the subframe, wherein the linkage has a hinge joint member having an upper leaf member pivotally connected to a lower leaf member for raising the elevated end of the hoist frame, wherein the linkage further includes a first pivot bar for moveably connecting the upper leaf member to the first and second parallel frame members of the hoist frame, and a second pivot bar for moveably connecting the lower leaf member to the first and second parallel subframe members. The hoist system also includes a connection bracket at a predetermined location for securely bolting the first and second pivot bars to the subframe and the hoist frame, for engaging and supporting the linkage at respective positions along the subframe and the hoist frame, enabling a respective configuration of the hoist system, and a winch assembly, retained in the elevated end of the hoist frame and extending beyond the pivot end, for raising the interchangeable body onto the hoist frame. Further, the hoist system has a body lock mechanism having pivotal mounting tabs welded to each subframe member and arms that actuate based on the height of hoist frame. The body lock arms are pivotally connected to the tabs, and the body lock arms engage with floor rails on the interchangeable body. Also included in the hoist system is an accessory mounting system having a plurality of accessory brackets disposed along the lengths of each of the first and second parallel subframe members, horizontal slots cut into the accessory brackets, and connection holes disposed on the accessory brackets for receiving bolts for fixedly connecting the accessory brackets to the parallel subframe members.

In accordance with another aspect of the invention, the hoist system body lock arms may pivot between an open position and a closed position. When the hoist frame is lowered, the hoist frame pushes on a lower portion of the body lock arms and closes a top portion of the body lock arms laterally towards the hoist system. The body lock arms are weighted such that they rest in the open position when the hoist frame is elevated, and the body lock arms engage with the floor rails on the interchangeable body when in the closed position. Additionally, the hoist system body lock mechanism may be configured such that none of pneumatics, hydraulics, or electric power are used to engage the body lock mechanism with the floor rails on the interchangeable body. The accessory brackets may define an “A-frame,” with a C-shaped cross-section, and the accessory brackets further include support strips disposed along the lengths of each of the first and second parallel subframe members, below the accessory brackets, which support strips may have a plurality of slots disposed along the length of the support strips. A support tab may be disposed on an underside of the accessory brackets, and the accessory bracket support tab may insert into the support strip slots.

In accordance with another aspect of the invention, at least one of the hoist system first and second parallel frame members further includes at least one body hold down that functions as a stop for halting forward motion of the interchangeable vehicle body onto the hoist frame. At least one of the first and second parallel frame members may further include at least one low friction roller to support the interchangeable vehicle body during movement along the hoist frame. At least one of the first and second parallel frame members may further include at least one greaseless slide strip, mounted along a side of the respective one of the first and second parallel frame members, for protecting against frictional damage. The hoist system may also have a hydraulic cylinder, connected to the subframe, for displacing the linkage to raise the elevated end of the hoist frame. Also, the hoist system may include a support section for supporting the tubing that provides hydraulic oil to a hydraulic winch motor or electrical wiring to an electrical motor of the winch assembly. Further, the hoist system support section may also have a flexible conduit for encompassing the electrical wiring, wherein the flexible conduit is retained in place by a support structure which can be secured to a stable surface on the hoist system. The hoist system may have a pump plate cover, connected to one of the subframe or the pump plate, for protecting hydraulic and electrical components that power the hoist system from damage, which the pump plate cover may further include a flat top portion with at least one adjoining side portion, for substantially surrounding the hydraulic and electrical components.

In accordance with another aspect of the invention, a body lock mechanism for a hoist system for raising and mounting an interchangeable vehicle body onto a vehicle chassis, having a plurality of tabs disposed along the lengths of each of the first and second parallel subframe members, body lock arm disposed along the lengths of each of the first and second parallel subframe members, coinciding with the tabs, and connection holes disposed on the tabs for receiving bolts for pivotally connecting the body lock arms to the tabs. The body lock arms are pivotally connected to the tabs, and the body lock arms engage with floor rails on the interchangeable body. Additionally, the body lock mechanism may be configured such that the body lock arms pivot between an open position and a closed position. When the hoist frame is lowered, the hoist frame pushes on a lower portion of the body lock arms and closes a top portion of the body lock arms laterally towards the hoist system. The body lock arms are weighted such that they rest in the open position when the hoist frame is elevated, and the body lock arms engage with the floor rails on the interchangeable body when in the closed position. Further, the body lock mechanism may be configured such that none of pneumatics, hydraulics, or electric power are used to engage the body lock mechanism with the floor rails on the interchangeable body.

In accordance with another aspect of the invention, an accessory mounting system for a hoist system for raising and mounting an interchangeable vehicle body onto a vehicle chassis, having a plurality of accessory brackets disposed along the lengths of each of the first and second parallel subframe members, horizontal slots cut into the accessory brackets, and connection holes disposed on the accessory brackets for receiving bolts for fixedly connecting the accessory brackets to the parallel subframe members. Additionally, the accessory brackets may define an “A-frame,” with a C-shaped cross-section. The accessory brackets may further include support strips disposed along the lengths of each of the first and second parallel subframe members, below the accessory brackets. The support strips may have a plurality of slots disposed along the length of the support strips, a support tab disposed on an underside of the accessory brackets, and the accessory bracket support tab may insert into the support strip slots.

Other benefits and advantages of this invention will become apparent to those skilled in the art to which it pertains upon reading and understanding of the following detailed specification.

### III. BRIEF DESCRIPTION OF THE DRAWINGS

The disclosed hoist may take physical form in certain parts and arrangement of parts, embodiments of which will be described in detail in this specification and illustrated in the accompanying drawings which form a part hereof and wherein:

FIG. 1 is a perspective view of the complete hoist system 100;

FIG. 2 is a perspective view of the subframe assembly 110;

FIG. 3 is a top view of the subframe 110;

FIG. 4 is a right side view of the subframe assembly 110;

FIG. 5 is a perspective view of the hoist frame 102 attached to the subframe 110;

FIGS. 6A and 6B are right side and front views, respectively, of the hoist frame 102 attached to the subframe 110;

FIG. 6C is a top section view along Section B-B in FIG. 6A;

FIG. 6D is a detail view of Section C in FIG. 6C;

FIG. 7 is an alternative perspective view of the complete hoist system 100;

FIG. 8 is a top view of the complete hoist system 100;

FIG. 9 is a right side view of the complete hoist system 100;

FIG. 10A is a bottom view of the complete hoist system 100;

FIG. 10B is a side section view along Section A-A in FIG. 10A;

FIG. 10C is a detail view of Section D in FIG. 10B;

FIG. 11 is a detail view of the hoist body lock mechanism 240, with an interchangeable body 104 mounted to the hoist system 100;

FIG. 12 is a front left detail view of the hoist body lock mechanism 240, with an interchangeable body 104 mounted to the hoist system 100;

FIG. 13 is a top view of the hoist body lock mechanism 240;

FIG. 14A is a perspective view of the hoist body lock mechanism 240 in the closed position 244;

FIG. 14B is a perspective view of the hoist body lock mechanism 240 in the open position 246;

FIG. 15A is an alternative perspective view of the hoist body lock mechanism 240 in the closed position 244, with an interchangeable body 104 mounted to the hoist system 100;

FIG. 15B is an alternative perspective view of the hoist body lock mechanism 240 in the open position 246, with an interchangeable body 104 mounted to the hoist system 100;

FIG. 16 is a perspective view of the accessory mounting system;

FIG. 17 is a perspective view of an alternative embodiment accessory mounting system;

FIG. 18 is a detail view of an embodiment of the accessory mounting system;

FIG. 19 is a perspective view of an accessory 260 mounted to a hoist system 100, using an accessory mounting system;

FIG. 20 is a detail view of a linkage connection bracket according to an exemplary embodiment of the present invention;

FIG. 21 is an overhead view of an alternative embodiment of a support section according to the present invention;

FIG. 22 is a side view of an alternative embodiment of a pump cover according to the present invention;

FIG. 23 is a rear view of an alternative embodiment of a pump cover according to the present invention;

FIG. 24 is an overhead view of an alternative embodiment of a pump cover according to the present invention;

FIG. 25 is a perspective view showing the right side of an alternate embodiment of a hoist system for raising and mounting an interchangeable vehicle body onto a vehicle chassis according to the present invention;

FIG. 26 is an oblique view of an alternative embodiment of a mounting portion according to the present invention;

FIG. 27 is a side oblique view of an engaging pin according to an embodiment of the present invention;

FIG. 28 is a top view of the engaging pin according to an embodiment of the present invention shown in FIG. 27;

FIG. 29 depicts the winch assembly according to an embodiment of the present invention.

### IV. DETAILED DESCRIPTION

Referring now to the drawings wherein the showings are for purposes of illustrating embodiments of the article only and not for purposes of limiting the same, and wherein like reference numerals are understood to refer to like components:

FIG. 1 is a perspective view showing an exemplary embodiment of a hoist system 100 according to the present invention. The hoist system 100 includes a hoist frame 102 for raising and mounting an interchangeable vehicle body onto a vehicle chassis. The hoist frame 102 is defined by first and second parallel frame members 102a, 102b. The hoist frame 102 is provided for slidably supporting the interchangeable body 104. The hoist frame 102 includes a pivot end 102p, about which the hoist frame 102 pivots, and an elevated end 102e, which is elevated when raising and mounting the interchangeable vehicle body 104, as will be described in greater detail hereinbelow. The frame members 102a, 102b extend along the longitudinal axis of the hoist frame 102 that extends between the elevated end 102e and the pivot end 102p.

It is to be appreciated that the present specification includes descriptions of similar components such as the frame members 102a, 102b in which identical corresponding structures are described and given similar reference numerals. Insofar as both of such corresponding structures may not be clearly shown in a particular view, especially a detail view, it is to be understood and appreciated such corresponding structures resemble the structures that are clearly shown in the views.

As shown in FIGS. 1, 2, 3, 4, & 5 a subframe 110 is provided for ultimately connecting the hoist frame 102 to the vehicle chassis. The subframe 110 is defined by a bolt-on assembly for fixedly connecting the hoist frame 102 to the vehicle chassis. Specifically, the subframe 110 is connected to the vehicle chassis at the mounting brackets 116a, 116b, and the hinge assembly 130. The mounting brackets 116a, 116b are formed integrally with the subframe 110 and may include mounting portions that engage the vehicle chassis. The mounting portions may each include a series of mounting holes that receive bolts to enable the mounting brackets 116a, 116b, and thus the subframe 110 to be bolted to the vehicle chassis. Similar structures may be included on the hinge assembly 130 as will be explained hereinbelow. A cover 114 is provided to protect the pump from damage. The cover 114 can be made of metal or plastic or any other suitable material.

The subframe 110 is sized so that the mounting brackets 116a, 116b can be bolted on to first and second parallel vehicle chassis members. It is to be appreciated that the pump plate 114 can be easily bolted into different locations of the subframe 110 to accommodate different classes of vehicles and different hoist capacities and dump angles (as will be explained in greater detail hereinbelow). The subframe 110 thus eliminates the need for welding to the vehicle chassis and the resulting damage thereto. The mounting portions 116 are reinforced members for providing support to the hoist system 100. This enables the subframe 110 to be made of prefabricated sheet metal portions, which is a lighter, less expensive material than the structural steel used with previous type welded hoist systems, resulting in improved economy and efficiency with the present invention.

With further reference to FIGS. 1 and 8, a linkage is provided for connecting the hoist frame 102 to the subframe 110. The linkage is preferably a type of hinge joint member 120 for raising the elevated end 102e of the hoist frame 102. The hinge joint member 120 includes an upper leaf member 122 and a lower leaf member 124 which are pivotally connected to each other by a pin member 126.

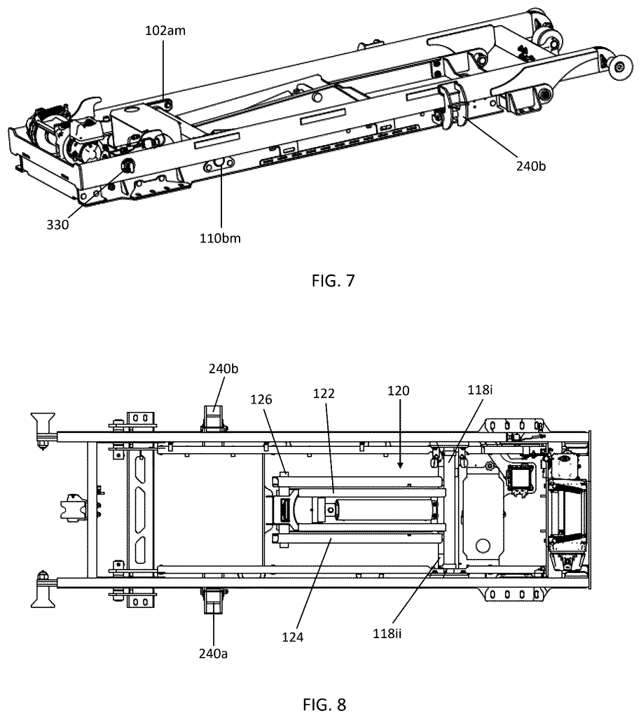

The upper and lower leaf members 122, 124 each include a pair of parallel structures designed to nest inside each other when the hoist system 100 is in a collapsed position as shown in FIGS. 1, 7, 8, & 10A, when the interchangeable body 104 (not shown in this view) is fully mounted and secured to the vehicle chassis. The upper leaf member 122 is moveably connected to the hoist frame 102 by a first pivot bar 118i that spans the parallel frame members 102a, 102b and secured to rotate therebetween during raising and lowering of the hoist system 100. The lower leaf member 124 is moveably connected to the subframe 110 by a second pivot bar 118ii to rotate therebetween during raising and lowering of the hoist system 100.

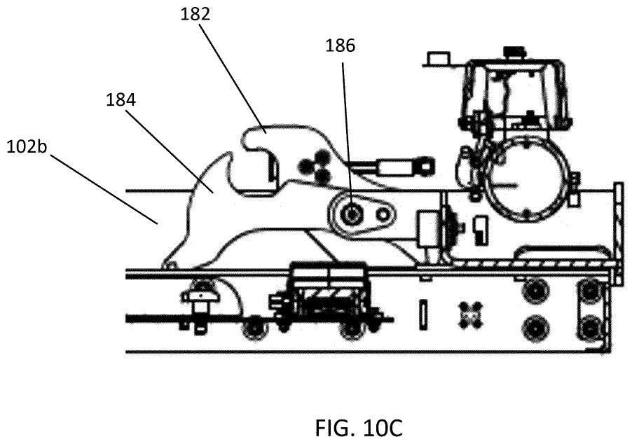

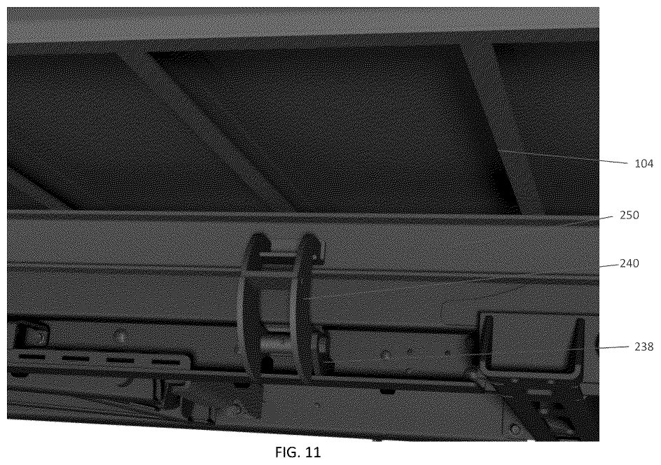

The hinge joint member 120 is raised and lowered to raise and lower the elevated end 102e of the hoist frame 102 using a hydraulic pump cylinder 128. The hydraulic pump cylinder 128 is also attached to the second pivot bar 118ii that engages the subframe 110 along with the lower leaf member 124. These aspects are especially shown in the top view of FIG. 8 along with the bottom view of FIG. 10A. The hydraulic pump cylinder 128 nests inside the lower leaf member 124 when in the collapsed position. Specifically, the hydraulic pump cylinder 128 is attached to the subframe 110, so that forces from the hydraulic pump cylinder 128 are transferred to the mounting points.

With continued reference to FIGS. 1, 2, 3, 6A, 6C, & 6D, a hinge assembly 130 is provided for pivotally connecting to the pivot end 102p of the hoist frame 102. Like the mounting brackets 116a, 116b, the hinge assembly 130 is a bolt-on assembly for fixedly connecting the hoist system 100 to the vehicle chassis. The hinge assembly 130 includes first and second pivot pins 132a, 132b, about which the hoist frame 102 pivots during raising and lowering of the hoist. The pivot pins 132a, 132b are mounted on each respective side of the hoist frame 102, through bores formed in respective parallel frame members 102a, 102b.

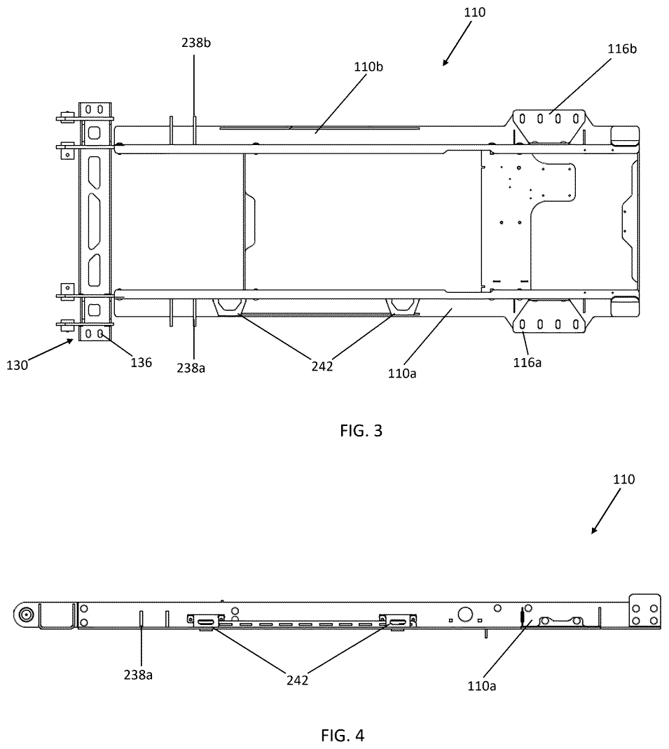

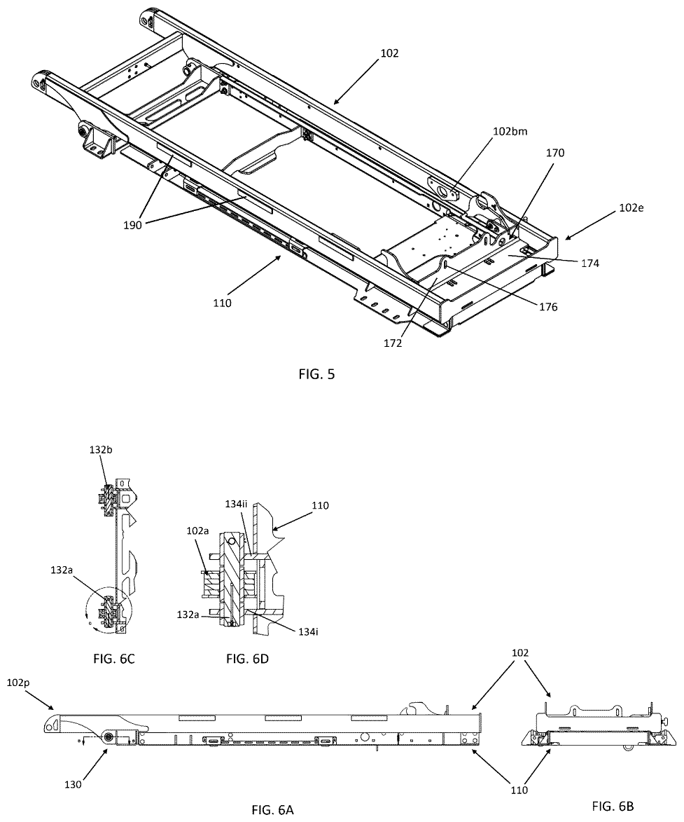

As particularly shown in the section and detail views of FIGS. 6C and 6D, respectively, which shows one side of the pivot end 102p, the first pivot pin 132a is received through bores in transverse portions 134i, 134ii of the hinge assembly 130, which are on opposite sides of the bore in the first parallel frame member 102a. The first pivot pin 132a can be of a common type structure and include a cotter pin for retaining the pin 132a against accidental slippage, as is understood in the art. It is to be appreciated that there is a similar structure associated with the second pivot pin 132b through the second parallel frame member 102b and the hinge assembly 130. As also shown in FIG. 3, the hinge assembly 130 includes a series of mounting holes 136 that receive bolts to enable the hinge assembly 130 to be bolted to the vehicle chassis using common type bolts as are known in the art.

As particularly shown in FIG. 1, a winch assembly 140 is retained in the elevated end 102e of the hoist frame 102. The winch assembly 140 includes a winch motor 142 that feeds out a cable that extends along the longitudinal axis of the hoist frame 102 to the pivot end 102p and connects to a hook, for raising the interchangeable body 104 onto the hoist frame 102. In the preferred embodiment, the hook is a swivel hook that swivels on the end to release any torsion on the cable 114 that might result from twisting, which would reduce the working life of the cable. In the preferred embodiment, the winch motor 142 is an electric motor, but can also be a hydraulic motor.

As particularly shown in FIG. 1, first and second pulleys or rollers 150a, 150b are provided at the pivot end 102p of the hoist body 102. The first and second rollers 150a, 150b are connected to the respective ends of the first and second parallel frame members 102a, 102b so as to face in an outward direction, away from the longitudinal axis of the hoist frame 102. In this manner, the rollers 150a, 150b engage the interchangeable body during raising and mounting to the hoist 100, to provide low friction support during movement. In the preferred embedment, as also shown in FIG. 1, castings 150ai, 150bi are formed onto the respective ends of the first and second parallel frame members 102a, 102b at the pivot end 102p for connecting the first and second pulleys 150a, 150b to the hoist frame 102.

As particularly shown in FIG. 1, a V-roller 160 is provided on the cross-member 160a between frames 102a and 102b. In the preferred embodiment, the V-roller 160 is a greaseless V-roller assembly for slidably supporting the cable of the winch assembly 140 having a “V-shaped” profile with a tapered section in the middle of the V-roller 160 having a narrower diameter than the diameter at the ends of the V-roller 160. In this manner, the V-roller 160 provides support and guidance for the cable when raising the interchangeable body 104 onto the hoist frame 102. In the preferred embodiment, the V-roller 160 is formed of a polymer material such as Nylatron to replace the metal rollers used in previous type devices, thereby further reducing wear and tear on the cable and not requiring grease.

As particularly shown in FIGS. 1, 5, & the detail view FIG. 10C, a back plate or winch plate 170 is attached to the elevated end 102e of the hoist frame 102 and is used to support the winch assembly 140. The winch plate 170 is a formed piece of sheet metal that replaces the single tube at the front of the previous type devices. The main advantage to the winch plate 170 compared to the previous type devices is that it allows the winch assembly 140 to be mounted in two planes verses a single plane as with the single tube design of the previous type devices. The winch plate 170 includes two perpendicular sides, a first side 172 and a second side 174, and each side 172, 174 has a set of oblong holes 176 for connecting to two respective perpendicular sides of the winch assembly 140. In this manner, the winch plate 170 supports the winch assembly 140 in two separate planes, providing greater securement of the winch assembly 140. Also, the winch plate 170 provides additional room for accommodating the swivel hook and cable.

Behind the winch plate 170 are front body hold downs 180, 182 and a body lock 184. As an interchangeable body 104 is being drawn up with the cable, it encounters a winch stop switch near the body hold down 182 which sends a signal to the system indicating contact with the body 104 and thus discontinues electrical power, which thereby stops the winch motor 142, halting the forward advance of the body 104. The body lock 184 includes an engaging hook to retain the body 104 in a secure position. The front body hold down 180 is similar to front body hold down 182 but does not have a connecting hook and functions as a stop for halting forward motion. The body lock 184 is assembled with a removeable and greaseable shaft 186, which enables replacement of the body lock 184 in the event of damage, as compared with the previous type devices in which a corresponding component is welded. This allows for quick replacement in the field verses the welded-on method from the previous type devices which would require grinding, welding, and additional paint work when the lock part needs replacement. In addition, a quick release pin 330 holds body lock 184 in place, securing an interchangeable body 104 to hoist 100 while dumping.

FIG. 5 shows particular details of a slide strip 190. There can be a slide strip 190 mounted to each of the parallel frame members 102a, 102b, preferably on an exterior side, facing outwardly away from the longitudinal axis of the hoist frame 102, to protect the parallel frame members 102a, 102b from destructive contact with the interchangeable body 104. The slide strip 190 is preferably a flat strip affixed to the frame members 102a, 102b. There can be a plurality of slide strips 190 mounted by welding or with screws having recessed heads onto the exterior sides each of the parallel frame members 102a, 102b in order to provide additional low friction surfaces.

In the preferred embodiment, the slide strips 190 are greaseless slide strips formed of a low friction material to support the interchangeable vehicle body during movement along the hoist. In the preferred embodiment, the slide strips 190 are formed of steel reducing wear and tear on the system but could also be made of Nylatron or other polymer material. In particular, the slide strips 190 (and other Nylatron and other polymer parts described herein) reduce metal-on-metal contact between the hoist system 100 and the interchangeable bodies 104, which can expose bare metal to the elements, causing rust, which can shorten the useful life of the hoist system 100. Also, the Nylatron slide strips 190 can be replaced when worn out, further extending the useful life of the hoist system 100.

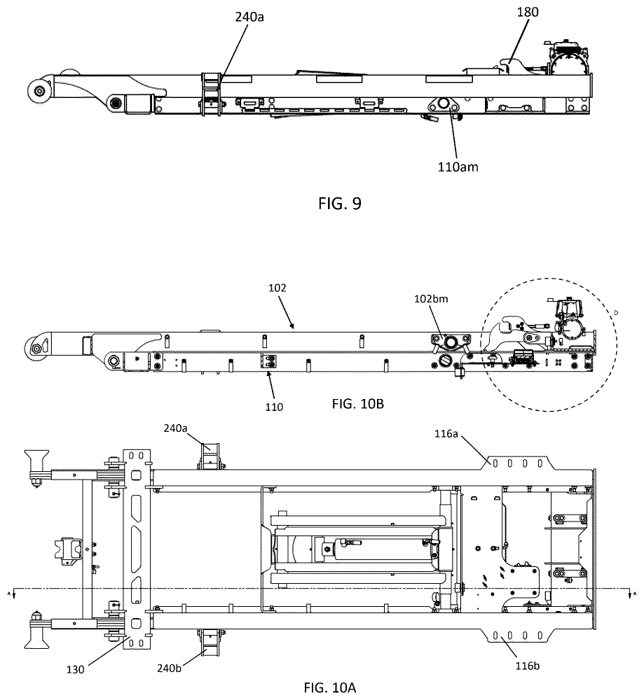

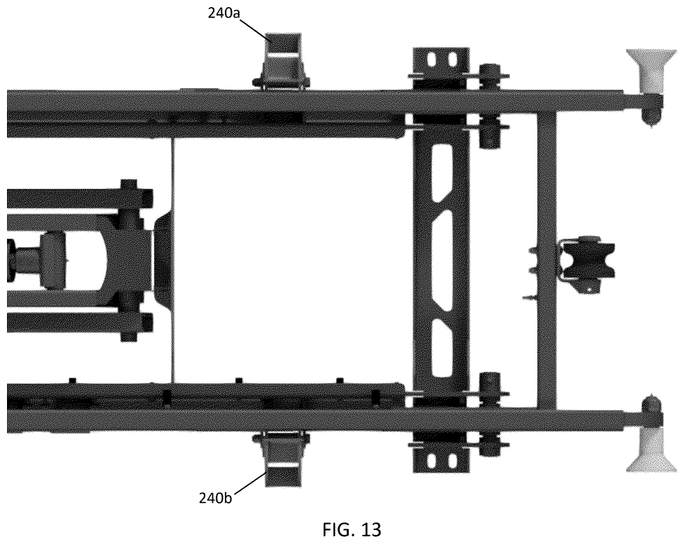

FIGS. 1, 2, 3, 4, 7, 8, 9, & 10A and the detail and rear views of FIGS. 11, 12, 13, 14A, 14B, 15A, & 15B show particular details of a body lock mechanism 239 for the hoist system 100. The hoist system 100 may have a body lock mechanism 239 having a plurality of tabs 238a, 238b disposed along the lengths of each of the first and second parallel subframe members 110a, 110b, a plurality of body lock arms 240a, 240b disposed along the lengths of each of the first and second parallel subframe members 110a, 110b, coinciding with the tabs 238a, 238b, and connection holes disposed on the tabs 238a, 238b for receiving bolts for pivotally connecting the body lock arms 240a, 240b to the tabs 238a, 238b. The tabs 238a, 238b may be oriented parallel to each other and oriented perpendicular to the first and second parallel subframe members 110a, 110b. The body lock arms 240a, 240b may be pivotally connected to the tabs, and the body lock arms 240a, 240b may engage with floor rails 250 on the interchangeable body 104. The body lock arms 240a, 240b may pivot between an open position 246 and a closed position 244. When the hoist frame 102 is lowered, the hoist frame 102 pushes on a lower portion of the body lock arms 240a, 240b and closes a top portion of the body lock arms 240a, 240b laterally towards the hoist system 100. The body lock arms 240a, 240b may be weighted such that they rest in the open position 246 when the hoist frame 102 is elevated, and the body lock arms 240a, 240b engage with the floor rails 250 on the interchangeable body 104 when in the closed position 244. Additionally, the hoist system body lock mechanism 239 may be configured such that none of pneumatics, hydraulics, or electric power are used to engage the body lock mechanism 239 with the floor rails 250 on the interchangeable body 104.

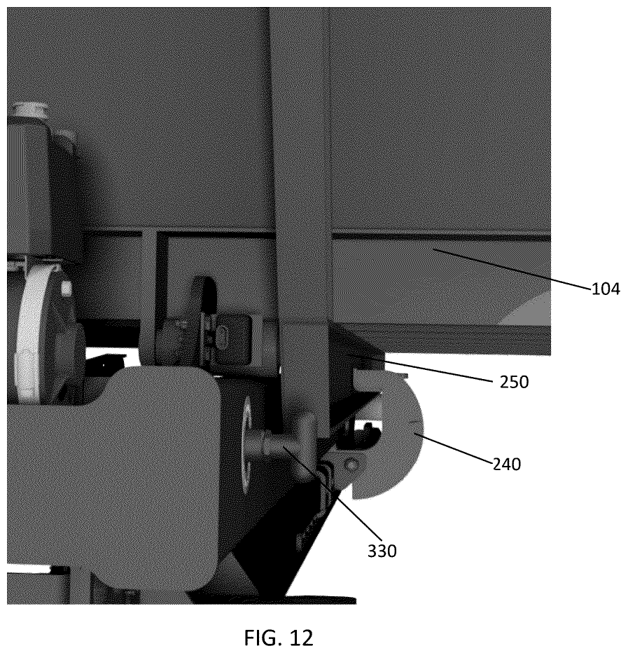

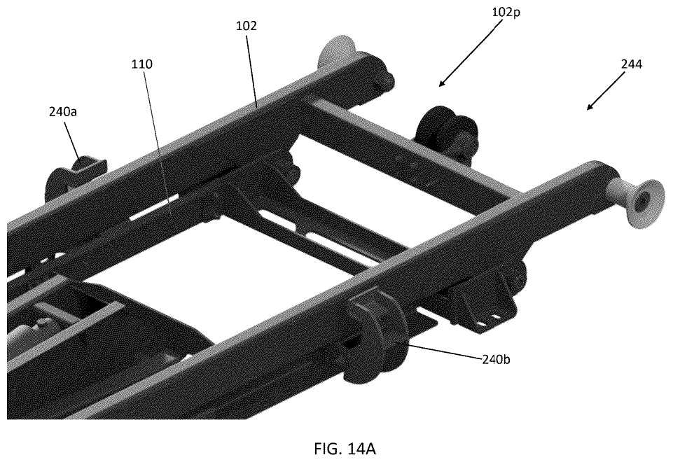

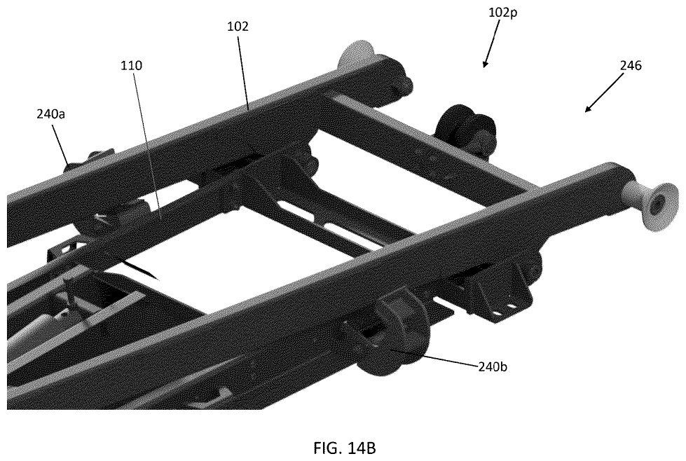

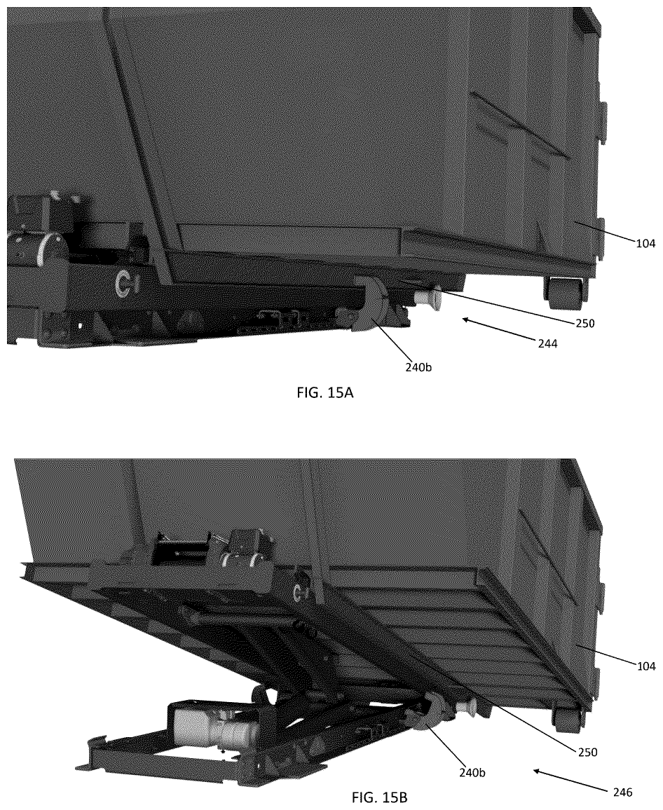

The body lock mechanism 239 operation is shown particularly in FIGS. 11, 12, 14A-B, & 15A-B, locking down a mounted interchangeable body 104. The body lock arms 240a, 240b are weighted such that they want to be in the open position 246 by default (FIGS. 14B and 15B). When the hoist system hoist frame 102 is lowered, the hoist frame 102 pushes on the lower portion of the body lock arms 240a, 240b and closes the top portion laterally towards the interchangeable body 104 (FIGS. 14A and 15A). Since the interchangeable bodies 104 use c-channel or formed channel floor rails 250, the body lock arms 240a, 240b engage with the body's floor rails 104 (FIGS. 11, 12, & 15A), preventing the interchangeable body 104 from separating from the hoist system 100. The body lock mechanism 239 need not rely on pneumatics, hydraulics, or electric power to operate. Similarly, the body lock mechanism 239 need not require the operator to flip a switch, press a button, or pull a lever. The body lock arms 240a, 240b may be engaged and disengaged solely by the raising and lowering of the hoist system hoist frame 102 during normal operation.

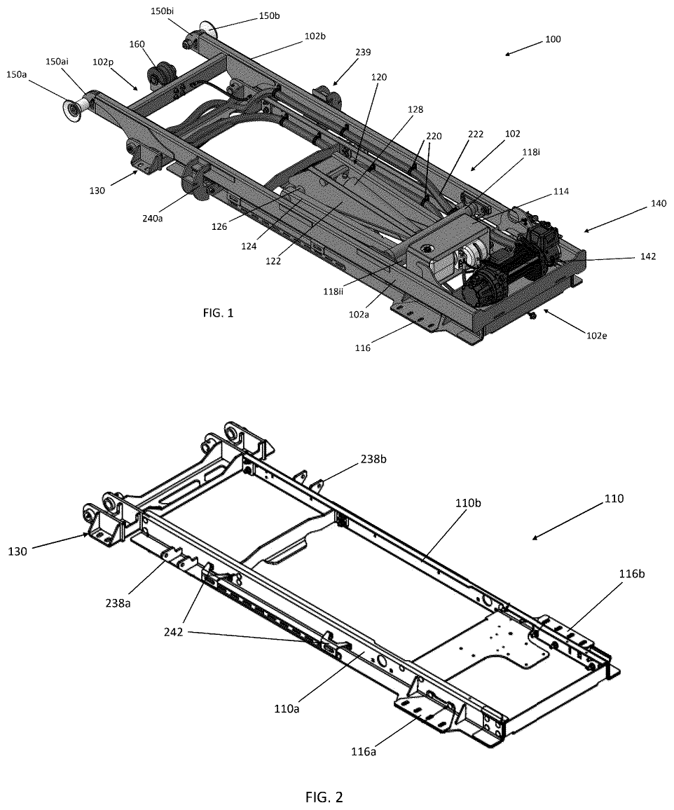

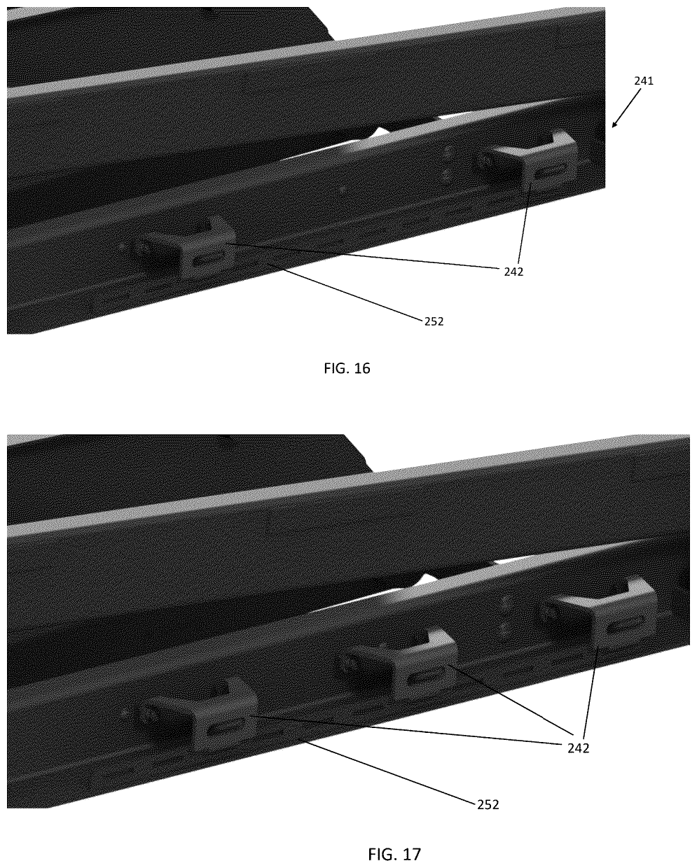

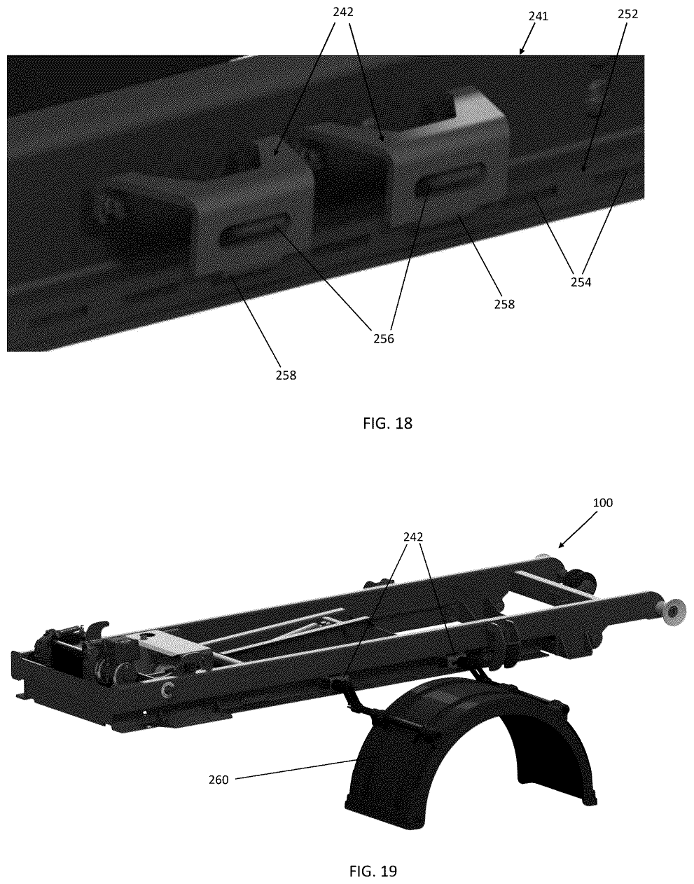

FIGS. 2, 3, & 4 and the detail views of FIGS. 16, 17, 18, & 19 show particular details of an accessory mounting system 241 for the hoist system 100. The accessory mounting system 241 may have a plurality of accessory brackets 242 disposed along the lengths of each of the first and second parallel subframe members 110a, 110b, horizontal slots 256 cut into the accessory brackets 242, and connection holes disposed on the accessory brackets 242 for receiving bolts for fixedly connecting the accessory brackets 242 to the parallel subframe members 110a, 110b. The accessory brackets 242 may define an “A-frame,” with a C-shaped cross-section, and the accessory brackets 242 may further include support strips 252 disposed along the lengths of each of the first and second parallel subframe members 110a, 110b, below the accessory brackets 242, which support strips 252 may have a plurality of slots 254 disposed along the length of the support strips 252. A support tab 258 may be disposed on an underside of the accessory brackets 242, and the accessory bracket support tab 258 may insert into the support strip slots 254.

The accessory mounting system 241 affords mounting points that may be of various shapes and sizes which will be secured to the hoist system subframe 110 in any number of positions along its length. The top portion of the accessory brackets 242 may be bolted securely, while also allowing angular adjustability. Such adjustment may be needed when mounting items 260 that extend laterally away from the system, including but not limited to fenders, tarp arms, or fuel filler neck brackets, amongst other accessories.

The present hoist system is specifically sized and weight-reduced to accommodate use on “Class 3” trucks and vehicles of similar size. The present hoist system provides reduced scissor size, subframe height, and top frame tube size. The present hinge assembly is simplified. Winch capacity is less, but it operates quicker.

As shown in FIG. 1, the frame members 102a, 102b can include a support section 220 that provides a tubing support for tubing 222. The tubing 222 provides hydraulic oil to the hydraulic winch motor 142. The tubing 222 can alternatively enclose wiring for an electrical winch motor. It is appreciated in the art that using a hydraulic winch motor is a lower volume option that is needed for certain applications because it has a much greater duty cycle. However, it is to be appreciated that other types of winch motors 142 such as electric motors can alternatively be employed without departing from the invention.

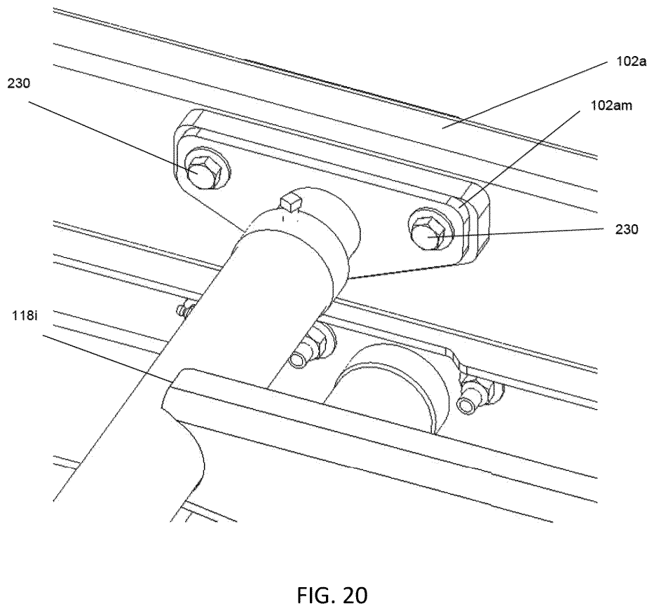

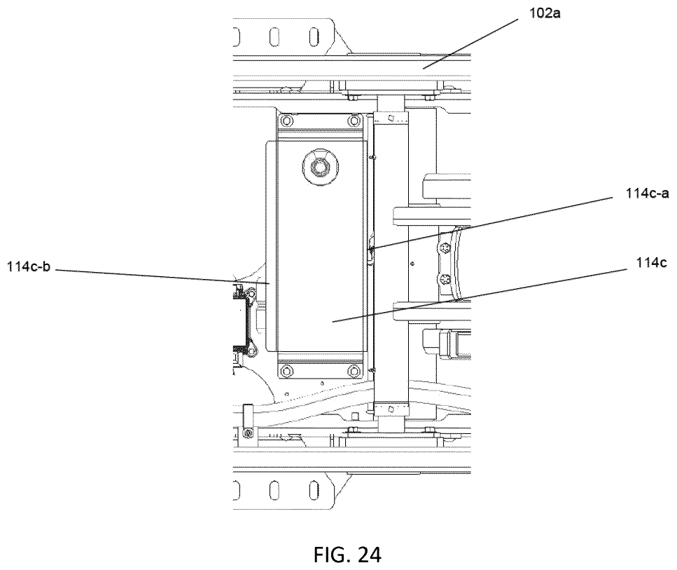

FIGS. 20-29 provide additional detail and/or alternate embodiments in accordance with the present invention. It is to be appreciated that like reference numerals refer to like elements in accordance with the embodiments described hereinabove.

As depicted in FIG. 20 is a detail view of a connection bracket 102am for connecting the first pivot bar 118i to the first parallel frame member 102a of the hoist frame 102. Though not explicitly shown, it is to be appreciated that an identical connection bracket 102bm can be provided for connecting the first pivot bar 118i to the second parallel frame member 102b of the hoist frame 102, and similarly identical connection brackets 110am, 110bm can also be provided for connecting the second pivot bar 118ii to the first and second parallel subframe members 110a, 110b of the subframe 110, in accordance with the descriptions of the other embodiments described hereinabove. In this manner, a plurality of connection brackets 102am, 102bm, 110am, 110bm can be provided for securely bolting the first and second pivot bars 118i, 118ii to the subframe 110 and the hoist frame 102 using a pair of bolts 230 received in respective suitable bolt holes formed in the respective parallel frame members 102a, 102b, 110a, 110b, for enabling the connection brackets 102am, 102bm to be securely bolted thereto. In this manner, the connection brackets 102am, 102bm engage and support the linkage at respective positions along the subframe 110 and the hoist frame 102, thereby enabling a respective configuration of the hoist system 100.

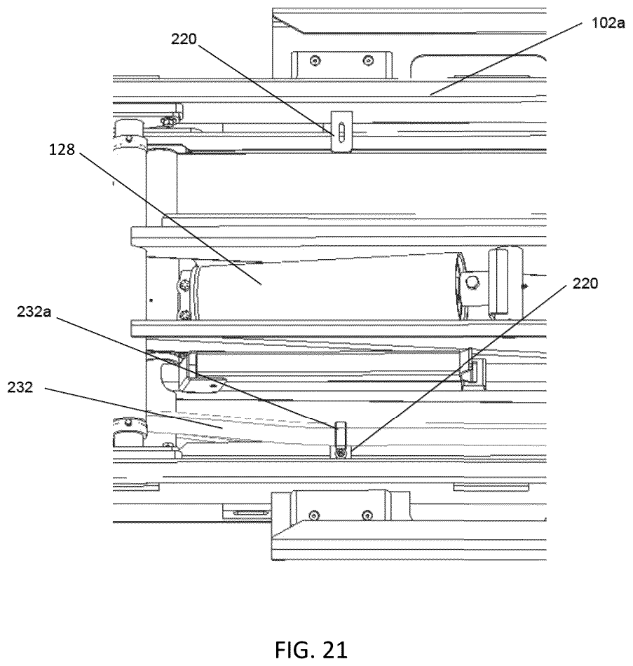

As shown in FIG. 21, the support section 220 can be provided for supporting for tubing 222 that provides hydraulic oil to a hydraulic winch motor of the winch assembly. The support section 220 can be connected to one of the frame members 102a, 102b or can span any other components perpendicular to the frame members 102a, 102b along the longitudinal extent of the hoist system 100. The support section 220 can include a flexible conduit 232 for encompassing wiring for an electrical winch motor. The flexible conduit 232 can be retained in place by a support structure 232a which can be secured to any stable surface on the hoist system 100. In an unillustrated alternate embodiment, the support section 220 can include a wire tray having flat, elongated securement surface 220a against one or more securing straps can be fastened for retaining the tubing 222. The securing straps can be a conventional “zip-tie” or any other suitable strap structure as would occur to those having skill in the art. The support section 220 can also include one or more additional flat, elongated securement surfaces formed perpendicularly to a mounting surface to provide additional protection for the tubing 222 on one or more respective sides. The additional surface can include one or more holes for enabling passage of the securing straps, such as enabling the “zip-ties” or bolts to be threaded therethrough, for example.

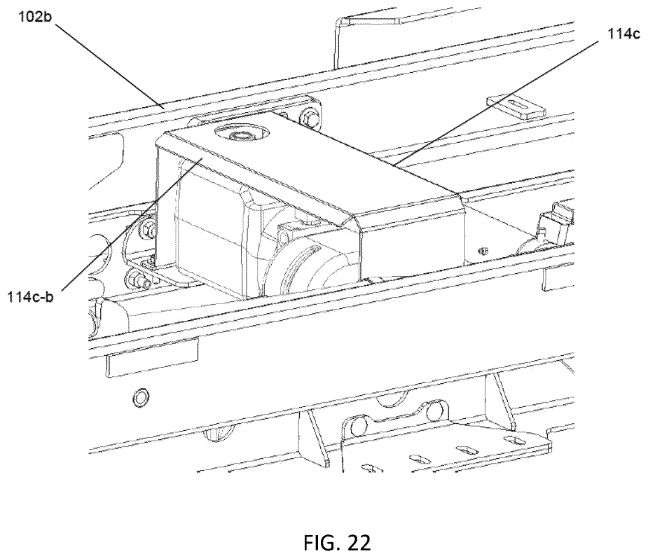

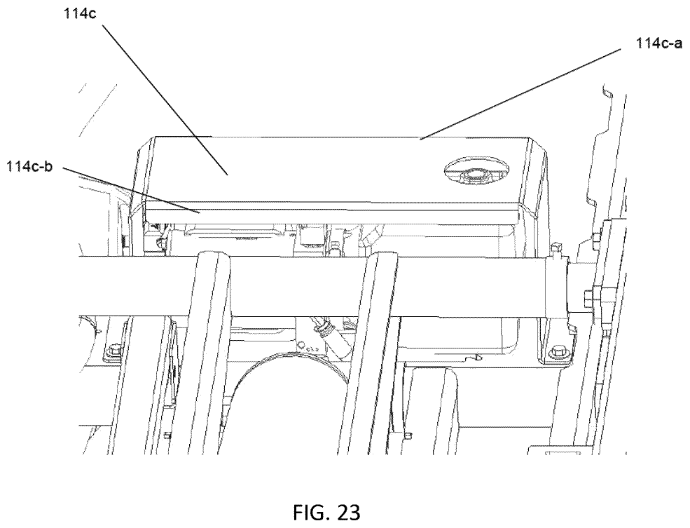

As shown in FIGS. 22, 23, & 24, the pump plate cover 114c is provided to protect the pump from damage. The cover 114c can be made of metal or plastic or any other suitable material. The pump plate cover 114c is connected to the pump plate 114, or either of the parallel subframe members 110a, 110b, for protecting hydraulic and electrical components that power the system from damage. The pump plate cover 114c is essentially a flat top portion that can include a first adjoining side portion 114c-a that is slanted at an oblique angle and has a lip parallel to the flat top portion, to cover and protect a front side. The pump cover plate 114c also includes a second adjoining side portion 114c-b that is also slanted at a perpendicular angle to cover and protect a back side, opposite the front side, for substantially surrounding the hydraulic and electrical components.

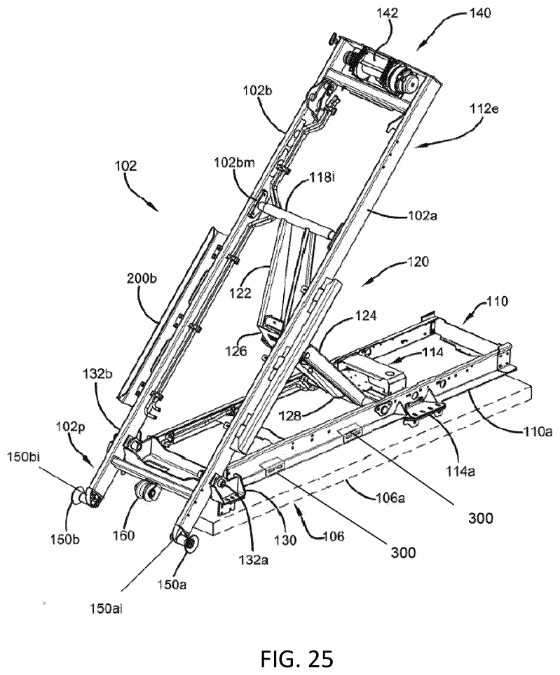

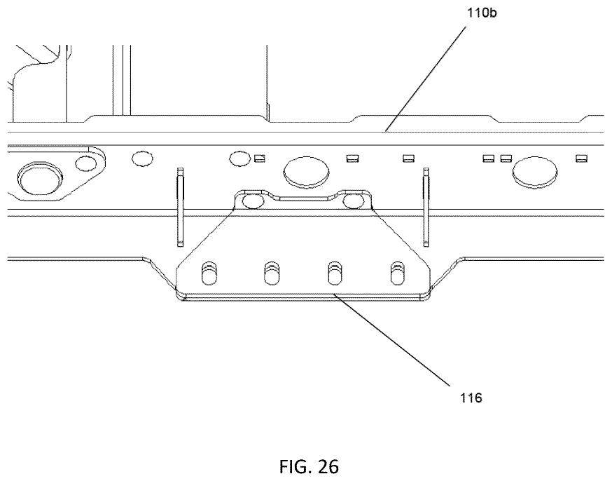

As depicted in FIGS. 25 and 26, a pivotal connection can be provided for pivotally connecting the pivot end 102p of the hoist frame 102 to the subframe 110. The pivotal connection is defined by the first and second pivot pins 132a, 132b, about which the hoist frame 102 pivots during raising and lowering of the hoist. The pivot pins 132a, 132b are mounted on each respective side of the hoist frame 102, through bores formed in respective parallel frame members 102a, 102b. Mounting portions 116 can be formed directly onto the subframe 110 at both the front and back of the subframe. In this manner, the subframe 110 can include first and second parallel subframe members 110a, 110b having mounting portions 116 on each of the subframe members 110a, 110b. The mounting portions 116 include a series of mounting holes for receiving bolts for fixedly connecting the subframe members 110a, 110b to the vehicle chassis through the use of mounting brackets 116a, 116b. In this manner, the mounting portions 116 are formed directly onto the subframe members 110a, 110b with no involvement with the pump plate 114 or the hinge assembly 130 as specifically characterized in the embodiments hereinabove.

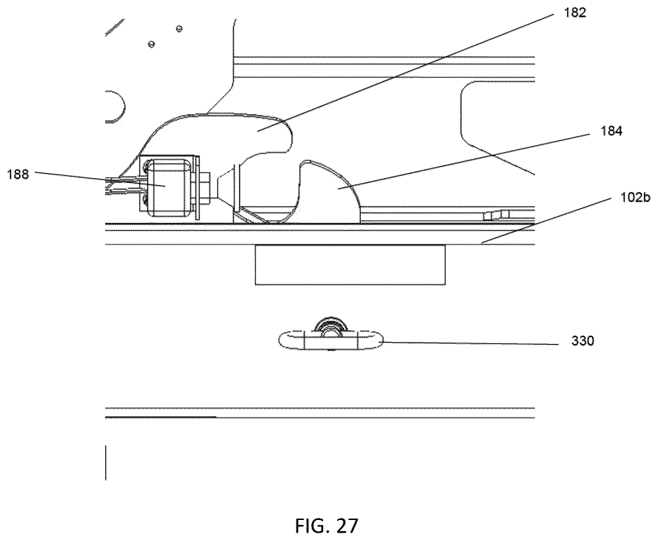

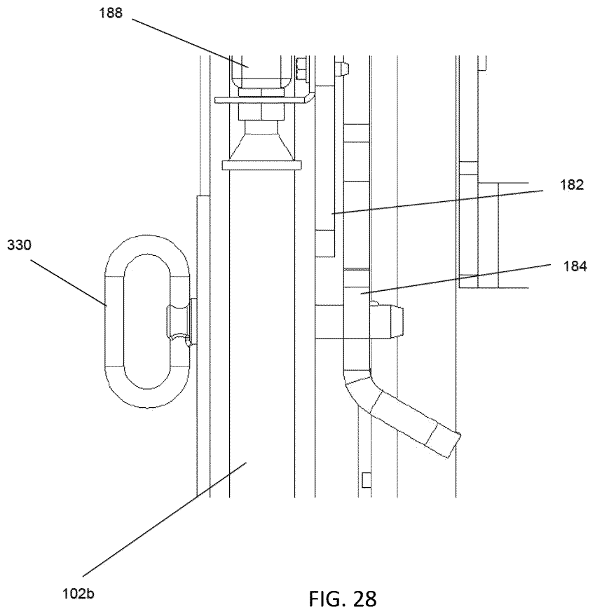

As shown in FIGS. 27 and 28, a body hold down 182 in accordance with the embodiment described hereinabove is provided and includes an engaging hook (body lock) 184 for retaining the interchangeable body 104 in a secure position upon the hoist frame 102. The body lock 184 is assembled with a removeable and greaseable shaft 186, which enables removal and replacement of the body lock 184 in the event of damage. A winch stop switch 188 is provided near the body hold down 182 which signals contact with the body 104 and discontinues electrical power, which thereby stops the winch motor 142. A quick release pin 330 is mounted through one of the parallel frame members 102a, 102b of the frame 102 for securing the body lock 184 to the hoist frame 102. The quick release pin 330 includes a first end having a ball detent or a hole for receiving a cotter pin for retaining the body lock 184 to the hoist frame 102 and second end having a grippable handle for withdrawing the quick release pin 330 from the body lock 184 and the parallel frame member 102a, 102b of the frame 102.

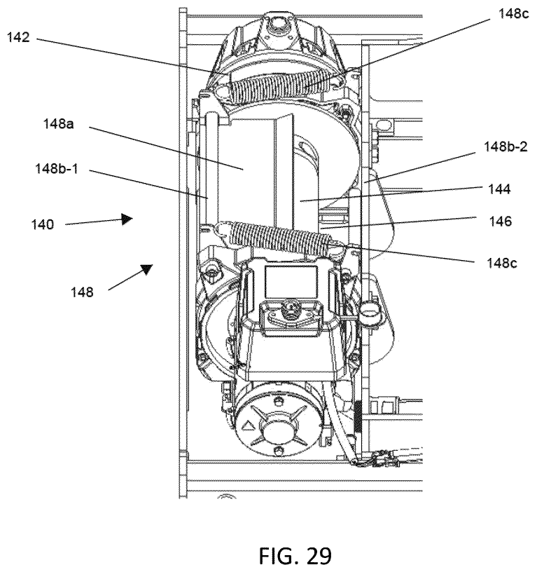

As shown in FIG. 29, the winch assembly 140 includes the winch motor 142 that feeds out the cable 144 in a direction that extends along the longitudinal axis of the hoist frame 102 to the pivot end 102p and connects to the hook 146, for raising the interchangeable body 104 onto the hoist frame 102. A winch cable tensioning component can include a lid 148a which can pivot along a first frame member 148b-1 which cooperates with a second frame member 148b-2 to hold down the cable 144 and thereby prevent the cable 144 from unraveling from the winch drum. Alternatively, a stow hook component 148 can include a conventional loop for stowing the hook 146.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A hoist system for raising and mounting an interchangeable vehicle body onto a vehicle chassis, comprising:
a hoist frame comprising first and second parallel frame members, extending along a longitudinal axis of the hoist frame between an elevated end and a pivot end, for slidably supporting the interchangeable vehicle body;
a subframe comprising first and second parallel subframe members and having mounting portions on each of the subframe members, the mounting portions including a series of mounting holes for receiving bolts for fixedly connecting to the vehicle chassis;
a pivotal connection for pivotally connecting the pivot end of the hoist frame to the subframe;
a linkage for connecting the hoist frame to the subframe, wherein the linkage comprises a hinge joint member having an upper leaf member pivotally connected to a lower leaf member for raising the elevated end of the hoist frame, wherein the linkage further comprises a first pivot bar for moveably connecting the upper leaf member to the first and second parallel frame members of the hoist frame, and a second pivot bar for moveably connecting the lower leaf member to the first and second parallel subframe members;
a plurality of connection brackets at bracket locations for securely bolting the first and second pivot bars to the subframe and the hoist frame, for engaging and supporting the linkage at respective positions along the subframe and the hoist frame, enabling a respective configuration of the hoist system;
a winch assembly, retained in the elevated end of the hoist frame and extending beyond the pivot end, for raising the interchangeable body onto the hoist frame;
a body lock mechanism having a plurality of tabs disposed along the lengths of each of the first and second parallel subframe members, a plurality of body lock arms disposed along the lengths of each of the first and second parallel subframe members, coinciding with the tabs, and connection holes disposed on the tabs for receiving bolts for pivotally connecting the body lock arms to the tabs;
wherein the body lock arms are pivotally connected to the tabs, and the body lock arms engage with floor rails on the interchangeable body;
an accessory mounting system having a plurality of accessory brackets disposed along the lengths of each of the first and second parallel subframe members, horizontal slots cut into the accessory brackets, and connection holes disposed on the accessory brackets for receiving bolts for fixedly connecting the accessory brackets to the parallel subframe members.

2. The hoist system of claim 1, wherein:
the body lock arms pivot between an open position and a closed position;
when the hoist frame is lowered, the hoist frame pushes on a lower portion of the body lock arms and closes a top portion of the body lock arms laterally towards the hoist system;
the body lock arms are weighted such that they rest in the open position when the hoist frame is elevated; and
the body lock arms engage with the floor rails on the interchangeable body when in the closed position.

3. The hoist system of claim 1, wherein none of pneumatics, hydraulics, or electric power are used to engage the body lock mechanism with the floor rails on the interchangeable body.

4. The hoist system of claim 1, wherein the accessory brackets define an “A-frame,” with a C-shaped cross-section.

5. The hoist system of claim 1, wherein the accessory brackets further comprise:
support strips disposed along the lengths of each of the first and second parallel subframe members, below the accessory brackets;
the support strips having a plurality of slots disposed along the length of the support strips;
a support tab disposed on an underside of the accessory brackets; and
wherein the accessory bracket support tab inserts into the support strip slots.

6. The hoist system of claim 1, wherein at least one of the first and second parallel frame members further comprises at least one body hold down that functions as a stop for halting forward motion of the interchangeable vehicle body onto the hoist frame.

7. The hoist system of claim 1, wherein at least one of the first and second parallel frame members further comprises at least one greaseless slide pad formed of a low friction material to support the interchangeable vehicle body during movement along the hoist frame.

8. The hoist system of claim 1, wherein at least one of the first and second parallel frame members further comprises at least one greaseless slide strip, mounted along a side of the respective one of the first and second parallel frame members, for protecting against frictional damage.

9. The hoist system of claim 1, further comprising a hydraulic cylinder, connected to the subframe, for displacing the linkage to raise the elevated end of the hoist frame.

10. The hoist system of claim 1, further comprising a support section for supporting for tubing that provides hydraulic oil to a hydraulic winch motor or electrical wiring to an electrical motor of the winch assembly.

11. The hoist system of claim 10, wherein the support section comprises a flexible conduit for encompassing the electrical wiring, wherein the flexible conduit is retained in place by a support structure which can be secured to a stable surface on the hoist system.

12. The hoist system of claim 1, further comprising a pump plate cover, connected to one of the subframe or the pump plate, for protecting hydraulic and electrical components that power the hoist system from damage.

13. The hoist system of claim 12, wherein the pump plate cover further comprises a flat top portion with at least one adjoining side portion, for substantially surrounding the hydraulic and electrical components.

14. A body lock mechanism for a hoist system for raising and mounting an interchangeable vehicle body onto a vehicle chassis, comprising:
a plurality of tabs disposed along the lengths of each of the first and second parallel subframe members;
a plurality of body lock arms disposed along the lengths of each of the first and second parallel subframe members, coinciding with the tabs;
connection holes disposed on the tabs for receiving bolts for pivotally connecting the body lock arms to the tabs;
wherein the body lock arms are pivotally connected to the tabs, and the body lock arms engage with floor rails on the interchangeable body;

15. The body lock mechanism of claim 14, wherein:
the body lock arms pivot between an open position and a closed position;
when the hoist frame is lowered, the hoist frame pushes on a lower portion of the body lock arms and closes a top portion of the body lock arms laterally towards the hoist system;
the body lock arms are weighted such that they rest in the open position when the hoist frame is elevated; and
the body lock arms engage with the floor rails on the interchangeable body when in the closed position.

16. The body lock mechanism of claim 14, wherein none of pneumatics, hydraulics, or electric power are used to engage the body lock mechanism with the floor rails on the interchangeable body.

17. An accessory mounting system for a hoist system for raising and mounting an interchangeable vehicle body onto a vehicle chassis, comprising:
a plurality of accessory brackets disposed along the lengths of each of the first and second parallel subframe members;
horizontal slots cut into the accessory brackets;
connection holes disposed on the accessory brackets for receiving bolts for fixedly connecting the accessory brackets to the parallel subframe members.

18. The accessory mounting system of claim 17, wherein the accessory brackets define an “A-frame,” with a C-shaped cross-section.

19. The accessory mounting system of claim 17, wherein the accessory brackets further comprise:
support strips disposed along the lengths of each of the first and second parallel subframe members, below the accessory brackets;
the support strips having a plurality of slots disposed along the length of the support strips;
a support tab disposed on an underside of the accessory brackets; and
wherein the accessory bracket support tab inserts into the support strip slots.
